(19) United States
(12) Patent Application Publication
(10) Pub. No.: US 2014/0082468 A1
(43) Pub. Date: Mar. 20, 2014

(54) Browser for rating pages with respect to search goals

(71) Applicant: Adrian Alexander May, (US)

(72) Inventor: Adrian Alexander May, (US)

(21) Appl. No.: 13/615,857

(22) Filed: Sep. 14, 2012

(51) Int. Cl. G06F 17/00

(52) U.S. Cl. 715/205

(57) ABSTRACT

The present invention relates to a computer-implemented system for web content management, wherein ratings of page relevance to search goals are used to streamline the interface and enhance search engine accuracy. The usage model combines a “view queue” of pages marked for imminent inspection together with “rate and go” buttons that simultaneously record a rating of the current page's relevance to the present search goal and dismiss the current page, replacing it with another from the view queue. For no extra effort, the user is rewarded with more intelligent window and history management based on knowledge of the ratings, whilst the search and authoring community benefits from uploading of the rating data. In an advanced embodiment, search attempts are automatically grouped into “search contexts” within which the relevance ratings are scoped.

### TECHNICAL FIELD OF THE INVENTION

The present invention relates to the field of web browsing applications and web search.

### BACKGROUND OF THE INVENTION

Current search engines rely on textual analysis of web pages to calculate the relevance of those pages to search terms that users may enter. These textual algorithms are now very advanced but operate without any explicit feedback from users. To judge the factual accuracy, completeness, persuasiveness, amusement value, etc. of a web page by textual analysis alone, a level of artificial intelligence comparable with human intelligence would be required. Search engines also judge web page quality by counting links to it from other pages. Humans create those links, so this indeed a measurement of human opinion. However, only web authors with particular personal goals create this information, not the users who wish to read the web, so the information is not representative of the feelings of the people the search engines aim to serve. Furthermore, link counting does not provide a clear mapping to search terms. Various systems attempt to elicit general quality ratings of pages from users, but they inconvenience the user without offering any reward and are therefore largely ignored. Search engines can tell which suggestions are clicked on by users, but at this moment in time the user is in no position to rate the page because he/she hasn't read it yet. Search engine accuracy is thus limited by lack of feedback about general page quality or the relevance of particular pages to particular search terms from users who have read the page with particular goals in mind.

Meanwhile, web browsers are rather cumbersome to use because they also lack information about page relevance. Browsers typically include a “history list” comprising pages viewed in the past, but without knowing which pages were better than others, the browser has no option but to store them all. This leads to such a long list that it is difficult for the user to find a particular page. Current browsers also provide a user-configurable tree of “favourites” alias “bookmarks” in the assumption that the user will take the time to maintain this tree. In reality, users spend little time creating new bookmarks or deleting obsolete ones, so the bookmark tree is rarely relevant to a user's current set of interests. The “Back” and “Forward” buttons date back to the earliest browsers but wrongly model the browsing activity as linear. A more tree-shaped browsing activity is supported by browsers that provide multiple tabs and windows, but the same problems appear (too many windows/tabs, no organization amongst them and tedious work to clear up the unwanted ones) for the same fundamental reason that no relevance feedback is available. Proposals have been made for gathering page quality feedback but these are either too tedious for users to be interested in, or the feedback is about page interest in general, rather than within the context of a particular search goal. In summary, for the sake of both user convenience and search engine accuracy, a method is needed for gathering relevance ratings whilst streamlining, rather than complicating, the user's browsing experience.

### SUMMARY

In view of the forgoing, it is an object of the present invention to provide a web browsing platform which gathers user ratings of the relevance of particular pages to particular “search contexts.”

Another object of the invention is to gather the relevance rating at the most opportune moment, i.e. when the user has finished reading a page and navigates away from it, which is achieved with a set of browser controls that combine navigating away from a page with specifying its rating in a single action.

Yet another object of the invention is to provide a more intelligent user interface which uses the relevance data to organise the set of currently readable pages, the way in which those pages are selected or recalled and the allocation of limited computing resources amongst those pages in a more automated way requiring less labour from the user; said interface being quite different from the contemporary model with its ‘Back’ and ‘Forward’ buttons, multiple tabs/windows, exhaustive history list and manual bookmarks.

Yet another object of the invention is to make the relevance data available to search engines and web content authors to help them optimise their service.

The above and other objects of the invention are achieved in the embodiments described herein by providing a web browsing platform in conjunction with a web search engine and rating server; the web browsing platform being aware of search terms either through a search term input box or by observing traffic to known search sites; the web browsing platform grouping individual search queries into search contexts either by way of manual controls or automatically by comparing search terms and/or their results with the current and past search contexts; the web browsing platform responding to the selection of a link by appending the target URL into a “view queue” and starting to pre-load and render the page invisibly; the web browsing platform being endowed with rating buttons whose effects are to note and upload the rating of the currently displayed page with respect to the current search context to the rating server and to replace the currently displayed page with the next fully loaded and rendered page in the view queue; and the web browsing platform uploading rating and other information to the rating server for later distribution to interested search engines and web authors.

It is a very useful innovation that the single action of using a rating button results in the two simultaneous effects of specifying the rating and switching to the next queued page. The web browsing platform may be further endowed with a graphical depiction of the history of search contexts, of which a single search context is considered currently active and whose highly rated pages can be seen listed and quickly recalled for viewing. In the variant with automatic context matching, the user is unlikely to explicitly search the context history; rather, entering search terms suffices to search both the history and the wider internet. In this case the graphical depiction of the search history may be omitted and the better rated pages in the search context made available by other means.

In the preferred embodiment, pages can be rated as (1) representative of the search goal and therefore worth making easily accessible in the long term, (2) interesting at first sight and likely to be read in detail soon, or (3) irrelevant and worth suppressing in the browser interface, search results and other pages whenever this search case is active. The data collected by the rating server, which may comprise several other user actions besides ratings, such as query input, entry into the view queue, interaction with a page, page dismissal and page recall, may be provided to search engines for use in their algorithms and to web authors. Alternatively, the rating server may be a specific search engine.

### BRIEF DESCRIPTION OF THE DRAWINGS

These and other features, aspects, and advantages of the present invention will become better understood when the following detailed description is read with reference to the accompanying drawings in which like characters and/or numerals represent like parts throughout the drawings, wherein:

FIG. 1 shows an exemplary operating environment provided by the system proposed in the present invention in which various embodiments can operate;

FIG. 2 is a simplified illustration of how the browsing platform may appear on the user access device in one embodiment;

FIGS. 3, 4 and 5 depict various aspects of the preferred embodiment of the present invention; and

FIG. 6 is a tabular representation of various information data uploaded by the browsing platform to the web server.

### DETAILED DESCRIPTION OF THE PREFERRED EMBODIMENTS

The present invention is now described with reference to the drawings, wherein like reference numerals are used to refer to like elements throughout. Though the present discussion provides examples in context of single window web browsing platform, one of ordinary skill in the art will readily comprehend that the application of these features and tools in other contexts, such as for conventional web browsing, is well within the scope of the present technique.

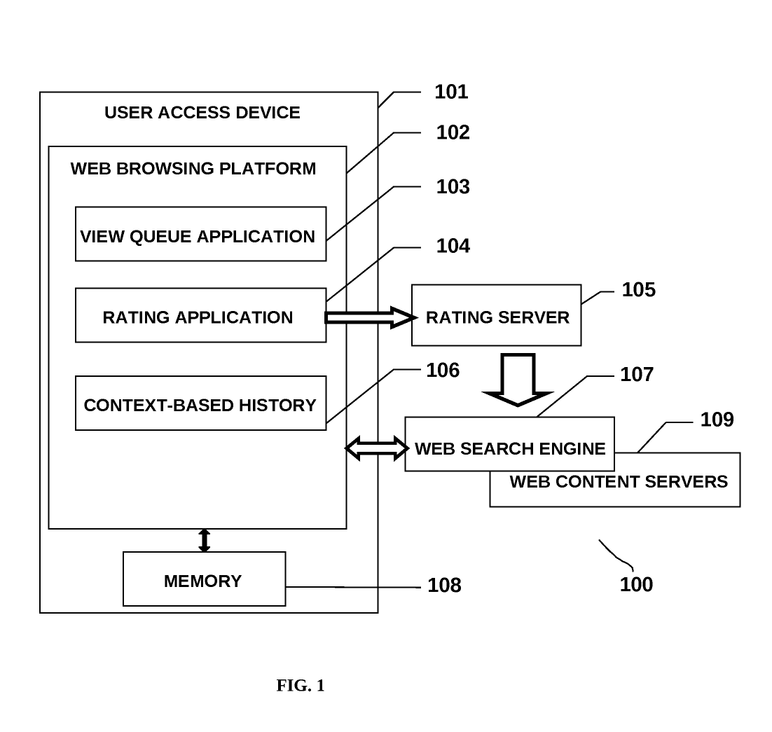

Referring now to FIG. 1 that shows an exemplary operating environment 100 provided by the computer-implemented system proposed in the present invention in which various embodiments can operate. The operating environment comprises a user access device 101 for enabling the user to view and manage one or more web contents through a user interface. The access device 101 may include multiple devices such as a desktop computer, a laptop computer, a tablet computer, a personal digital assistant (PDA), a smart phone, a mobile device, and so forth. The system further comprises a web browsing platform 102 accessible through the user interface. The web browsing platform 102 works in conjunction with a rating server 105, a web search engine 107 and a multiplicity of web content servers 109. The conjugated search engines in the preferred embodiment may include, but are not limited to, Google, Yahoo, Baidu, etc. As shown in FIG. 1 the web browsing platform 102 incorporates a view queue application 103, a rating application 104, and an application for creating context based history 106 all of which will be described later in the specification. The user access device 101 allocates a memory 108 for saving the above mentioned applications and other applications of web browsing platform 102 and for processing of data generated within the web browsing platform 102.

The web browsing platform 102 is moulded around a suggested user behaviour about which the following comments can be made. Firstly, a search typically comprises multiple attempts to send keywords to a search engine. Current browsers and search engines treat these attempts as unrelated, but in reality, both ergonomics and feedback can be enhanced by grouping them into “search contexts.” Secondly, the best moment to elicit a rating from the user is just when he or she finishes reading the page. This can be detected by the attempt to navigate to a different page. Thirdly, searching is modelled as a tree-like activity in which multiple candidates are explored, each possibly leading to more candidates. The user typically alternates between (1) collecting more candidates and (2) working through them in a process of elimination. In more detail, a search engine returns several suggestions, some of which are eliminated at first sight and some of which the user wishes to read. Upon reading the surviving candidates, more are eliminated until just a few remain. The ideal page might still not have been found, in which case a further iteration of summoning more search results occurs, either by requesting further pages of search results or by modifying the keywords, or by clicking on links in the pages already found, and this new set of candidates is again pruned down to a useful core. Eventually, the search finishes either successfully or unsuccessfully. The present invention seeks to support these expanding and contracting phases explicitly. Fourthly, there is a need to distinguish between short term and long term interest value of a page. Pages that have been requested but not yet read thoroughly are of short term interest. Those judged representative of the search goal are of long term interest and the user may wish to recall them at a later date, by which time they may have been removed from the web. Fifthly, search results are not the only pages that contain numerous links. For this reason, the present invention treats search results just like any other page. (Some embodiments may choose to treat search results as quite different from other pages, for instance, by capturing them programmatically via either “screen-scraping” or the API provided by the search engine, and displaying them in some special control. There are reasons to do this, such as removing already viewed results from the set returned by the search engine, allowing the user to customise the form in which results are displayed, keeping them visible whilst browsing, etc. Such techniques are within the scope of the present invention but the preferred embodiment considers them more useful in conventional browsers while the present invention largely eclipses their purpose.)

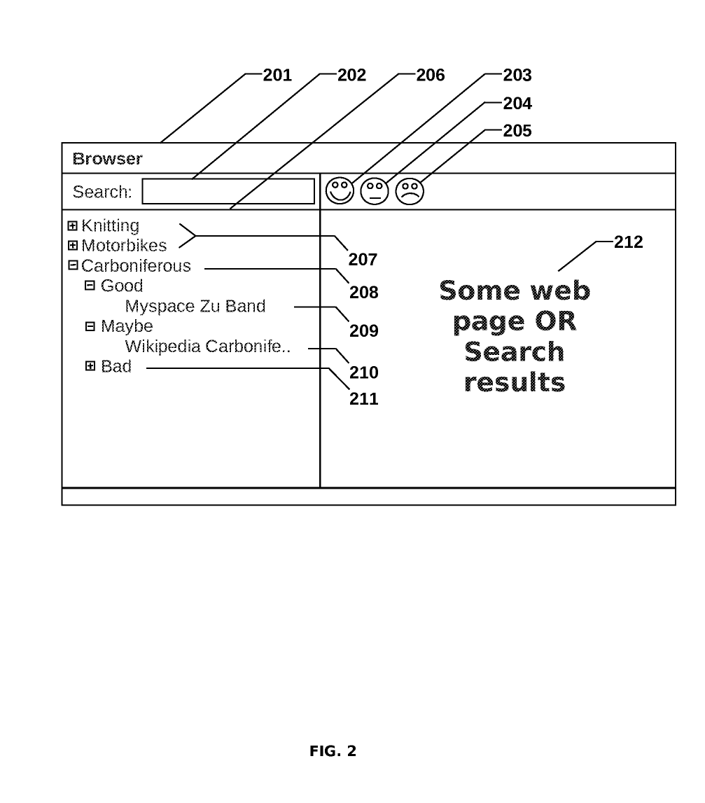

With the above goals in mind, a preferred embodiment of the present invention will now be described with reference to FIGS. 2, 3, 4 and 5. The description can be grouped into the topics of user interface appearance; overall flow of activity; search contexts; the view queue, default action on clicking a link, rating categories and effects of using rating buttons; the left pane showing contexts and useful pages; the suppression of used links; usage scenarios that don't resemble search; and uploading to the rating server.

A user interface suitable for devices with plenty of screen space will now be discussed with reference to FIG. 2. The web browsing platform 102 presents a graphical user interface 201 comprising a text input box 202 for search queries or direct URLs, three rating buttons 203, 204 and 205, a viewing area 212 for web pages and search results and a side pane 206, as well as the standard GIU controls typical of the operating system running on the user access device 101 for terminating the program, minimizing the window, summoning help, adjusting the font size, etc. The side pane 206 displays the history of previous search contexts 207 and a detailed view of the current search context 208. This detailed view 208 lists the highly rated pages 209, the pages marked for imminent closer inspection 210 and a collapsed tree node 210 containing pages rated as irrelevant to the search context. The collapsed nodes in the side pane, including the historical search contexts can be expanded by clicking on the [+] icon to their left. The preferred embodiment deliberately avoids depicting the view queue because users would expect to click on the listed pages to jump straight to them without rating the previous page, thus reducing the number of ratings obtained and creating a mass of pages the web browsing platform does not know how to organise, but embodiments which do depict the view queue are within the scope of the present invention.

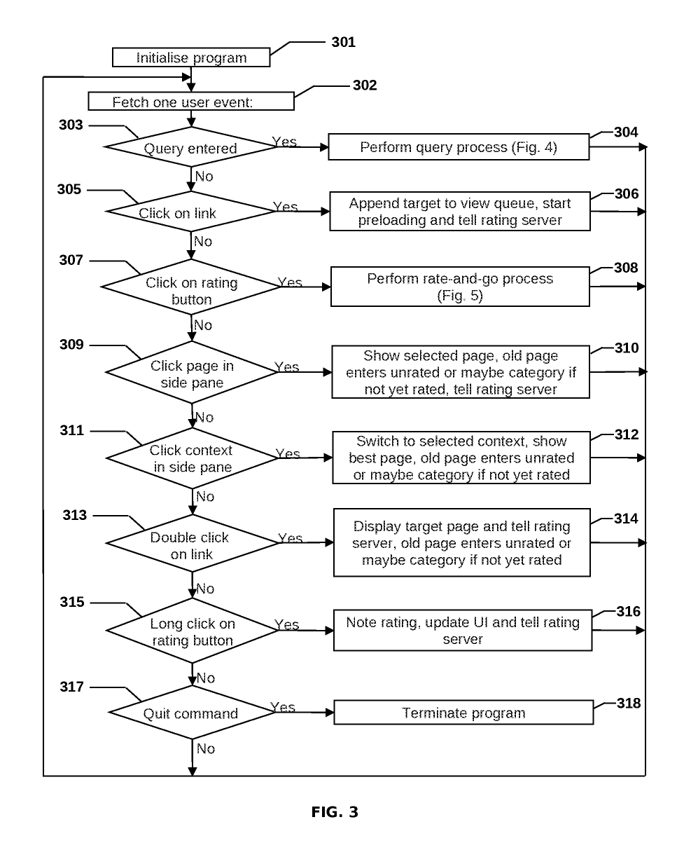

The overall flow of activity will now be discussed with reference to FIG. 3. The first three rows 303-308 correspond to the expanding and contracting phases of the suggested search behaviour described above. (1) When a search query is entered 303 into the search box 202 or intercepted en route to a search engine from the HTML form provided by the search engine, a context is selected or created, a suitable query is sent to the search engine and the results are displayed in the viewing area 212. This process 304 is discussed in more detail below. (2) While the user is viewing a page containing a multiplicity of links, whether it be a set of search results or any other page, he or she may click 305 on any number of them, which causes the link to be added 306 to the view queue 103 without dismissing the current page. (3) At any time, the user may click 307 a rating button 203-205 to add the current page to a rating category, whether it be search results or any other page, and replace it with another from the view queue in the viewing area. This process 308 is discussed in more detail below. In all three cases the rating server 105 is informed.

Over time, the above three use-cases have the effect of building up a multiplicity of search contexts each containing a fixed set of rating categories, each category containing a multiplicity of URLs. The side pane 206 presents a selection of the most imminently useful of these URLs on which the user can click 309 to summon the corresponding page 310 into the viewing area 212. If the page that was showing immediately before 309 occurs has not yet been rated, it is considered a “lost rating case” and is dealt with as discussed below. The user may also click 311 in the side pane 206 on a search context 207, 208 which has the effect of making that context the current one and summoning a page representative of it 312. The choice of which page this should be is discussed later. Selecting another context like this may also result in a lost rating case.

In the event that the user knows from past experience that a certain link leads exactly to the only page of interest, he or she may double click 313 on the link. The effect of this is to load, render and show the page immediately, in the manner of contemporary browsers. There is no effect on the view queue. Double-clicking a link may result in a lost rating case. Some embodiments may implicitly register a good rating for the summoned page, but the preferred one assumes that the rating event will occur later. Either way, the rating server is informed. 315-316 is a comparatively unimportant feature where the user may rate a page without dismissing it using a secondary gesture on a rating button, such as a long click.

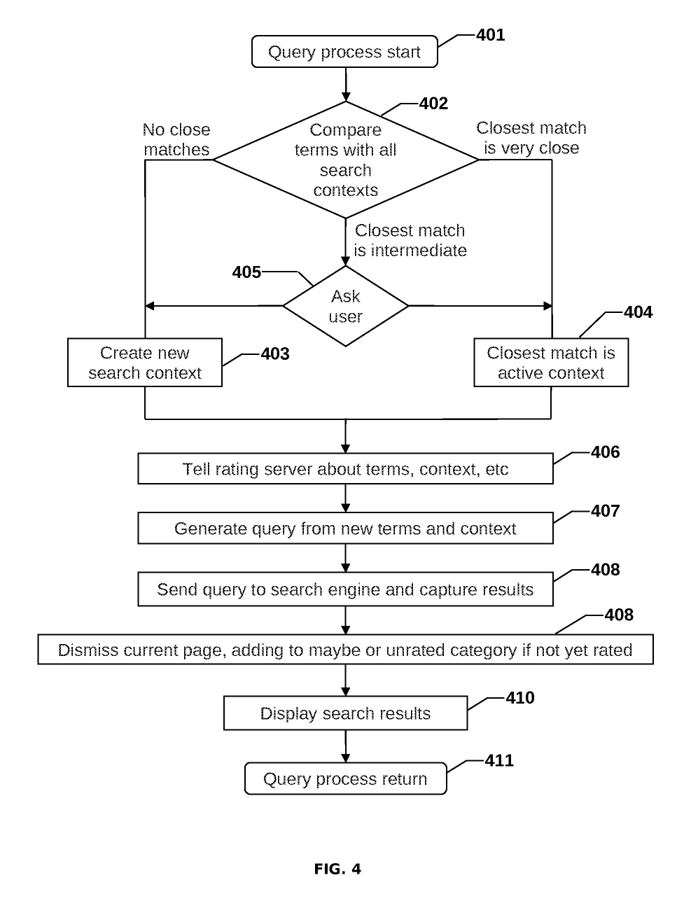

The generation and selection of search contexts within the query process 304 will now be discussed with reference to FIG. 4. Any browser may find out about the search terms by providing a search box, typically in a tool-bar, and/or by observing the traffic to know search URLs. The issue here is to identify “search contexts”, i.e., single subjects that the user wants to find out about. Typically, a single search context requires multiple attempts at entering search terms that yield relevant suggestions from the search engine. The relevance ratings described above are associated with search contexts, not with individual search attempts. We need some way of grouping the search attempts into search contexts. This can be done automatically or manually, and both approaches are covered by the present invention. Embodiments using the manual approach provide a button to start a new search context, or two search term input boxes: one for new contexts and one to modify the current context. There are many trivial variations of this. Embodiments using the automatic approach have just one input box and no such button, but examine the similarity of entered search terms to earlier searches, and perhaps the similarity of the search results they lead to, or even the similarity of the contents of the pages suggested by the search engine. This similarity measurement would vary between 0% and 100%. For values close to the extremes an automatic decision can be made, and for intermediate values the user might be asked whether to start a new search context or modify the existing similar one. The same similarity measurement may be made between the new search terms and the entire history of search contexts this user ever created, and in the event of a good match, the old search context may be reopened and augmented with the new activities. This is almost the same as saying that all searches start with the history before considering the wider internet. This would be the primary means of accessing history in the preferred embodiment, however, because limitations of processing speed on certain computers could make this impractical, a manual method of accessing history is also provided for. Such manual methods are discussed later in this detailed description.

FIG. 4 illustrates the automatic approach. When a new search query is input, a comparison 402 is made with all the contexts including the current one. If the query is truly novel a new context is created and made current 403. If a close match to any context is found, that context is made current if it isn't already the current one 404. For borderline cases the user may be prompted for a decision 405. The correct context having been ascertained, the ratings server may be informed 406. Advanced embodiments may generate a query from both the newly entered terms and the context history 407 to avoid repetition of the same results, whereas simple ones may simply use the input keywords verbatim. The query is sent and the results captured 408, after which the currently viewed page may be dismissed and replaced with the search results 409, 410. The case that the old page has not been rated by the time it gets replaced by the search results is one of many cases in which ratings cannot be obtained. These cases are discussed later.

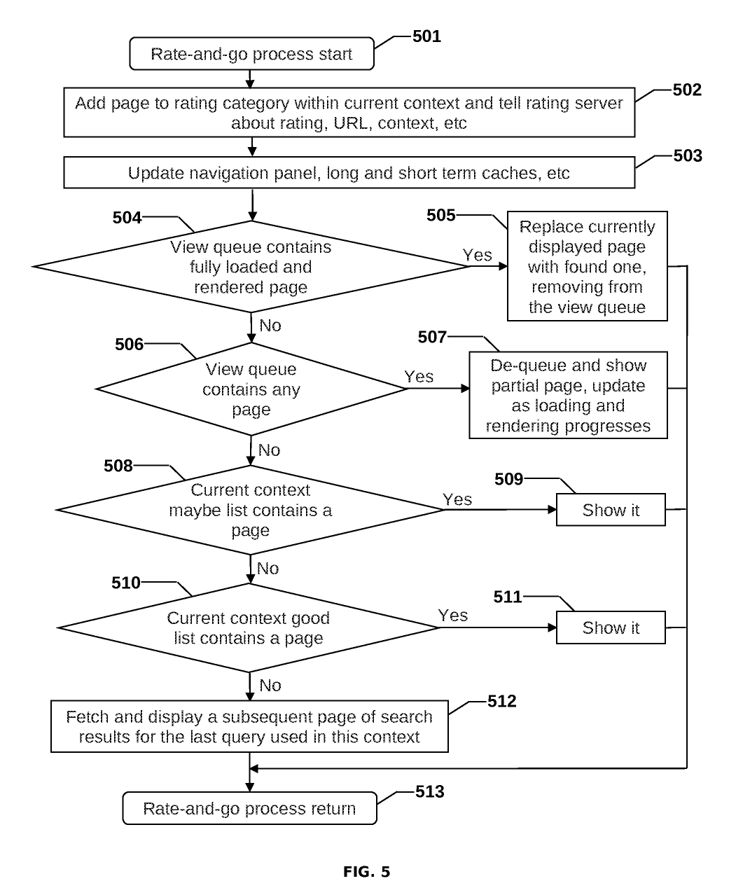

The view queue, default action on clicking a link, rating categories and effects 308 of using rating buttons will now be discussed with reference to FIG. 5. When a link is clicked 305, its target URL is added to the view queue 103 but the currently viewed page is not dismissed or replaced with any other. This enables several links from a given page to be added in quick succession in accordance with the expanding phase of the suggested usage model. When the user has finished with the current page, it may be dismissed by clicking 307 a rating button 203-205. This has the dual effects of adding 502 the earlier page to a rating category of the current search context 208 according to which of the three rating buttons was pressed, and summoning some other page from the view queue to replace the old page in the viewing area 212. The left pane is updated to reflect the addition of the page to the category 503 and the rating server 105 is informed about the rating 502. If a rating button is pressed for a page that already has a rating, the new rating simply overwrites the old one and the rating server is informed.

The selection of the page from the ones in the view queue is illustrated by 504-512. The pre-loading and rendering of the pages in the view queue was initiated at the moment they were added to the view queue (or perhaps earlier.) By the time a rating button is pressed, a subset of them has been fully loaded and rendered in invisible browser controls. If this subset is not empty 504, one of its members is chosen 505, probably the one added to the view queue earliest. Otherwise, partially loaded and rendered pages are considered 506. The choice may reflect the time of entry to the view queue, the completeness of rendering or both 507. When partially rendered pages are visible in the viewing area 212, they should update as their loading and rendering progresses in the manner of current browsers. When the view queue is empty, the choice of page is dependent on the embodiment. Sensible options include working through the pages given an intermediate rating 508-509, i.e., marked for imminent inspection; working through the highly rated pages 510-511; returning to the search results; or fetching a subsequent page of search results 512.

In order to be popular, the buttons and categories should provide the user with some practical benefit and are therefore defined in terms of their practical consequences: a low rating indicates that the user does not wish to be further distracted by this irrelevant page as long as the current search context is active. The web browsing platform responds by effectively censoring them from the user's eyes for that period. An intermediate rating is an act of procrastination: the user sees potential in the page but wishes to examine the other candidates and probably eliminate some of them before reading it in detail along with the other short-listed pages. The practical effect, then, is to make the page easily accessible during this search context until the page is otherwise rated. A high rating indicates that the page is so useful that a permanent mapping from the search context to the page should be retained. The page should also be cached permanently (or as long as memory permits) in case the page is deleted from the internet or edited, however, the user should still be able to access any updated version. There are many obvious options as to how the user may choose between cached and updated versions of pages.

Ratings of pages of search results are not particularly meaningful, but the buttons nevertheless have a practical benefit for the user. It is unlikely that a user would use the highest rating to store the search results for ever, but by choosing the intermediate or low category, he or she can specify whether or not that page of results is still of interest. The standard behaviour would have this effect, but some embodiments may choose to interpret the rating buttons in a special way when a page is known to contain search results. For instance, when the view queue is exhausted, some embodiments might choose to return to the search results. These embodiments could choose to show the original page of search results or a subsequent page depending on the rating with which the search results were dismissed. Such variations are well within the scope of the invention.

A question arises as to the ordering of retrieval from the view queue in the case that the view queue contains a mixture of links directly from the original search results mixed with links from pages reached indirectly via pages suggested by the search engine. For instance, (assuming all pages are loaded and rendered quickly such that the view queue ordering is preserved) if pages A, B and C were added to the view queue from the search results, and a link to page B1 was selected whilst viewing page B, should B1 or C be displayed first? Both options are credible, the former option more ergonomic but the latter simpler to implement. One skilled in the art would recognize a plethora of possible variations on this theme as part of the present invention.

One possible variation of the invention would equate the intermediate category and view queue. This combined category may then be accessible for page selection or invisible. The former option is equivalent to saying that single-clicked pages enter the middle category directly. The latter means that medium rated pages re-enter the view queue. Although considered inferior to the preferred embodiment, these variations are within the scope of the invention. There are also conceivable embodiments with multiple view queues either per search context or per page, the former supporting persistence of the view queue between sessions in a given context, and the latter meaning that selected pages are added to the view queue belonging to the page on which the link to the page is found.

Besides the three explicitly rated categories, various implicit categories (i.e. categories that represent implementation-dependent details which are automatically handled by the web browsing platform, as opposed to explicit categories which the user controls) can be proposed and may be of use to advanced embodiments. These include: pages that were displayed but not rated for any of a number of reasons; search suggestions that were presented but not added to the view queue or otherwise taken notice of; pages that were added to the view queue but not viewed; and pages that were jumped to directly with a double-click. These less important categories may be useful to the rating server even if they play no role in the user interface. It is also possible to gather implicit ratings of pages by measuring user “activity” within the page. This should be active interaction such as scrolling, pointing, highlighting, copy-pasting, etc., rather than merely having the page open, which alone does not indicate that the user is even using the user access device. Activity on a page is not in itself an indication of relevance or interest value; rather, it shows the web browsing platform that the page has been examined. Embodiments that use such activity measurements to decide how and when to make pages easily accessible to the user, or provide such information to search engines to use as they see fit are within the scope of the present invention. Some embodiments may also provide a means for the user to indicate that a page is good or bad in general, i.e. irrespective of any search goal. The former corresponds to Digg, Reddit, etc., while the latter would be novel and covered by the present invention.

There are situations in which no rating is obtained for a page, for instance, the page displayed when a double-click or new search query occurs is dismissed without the use of a rating button, and might not have been rated by that time. Options open to the embodiment in this situation include: prompting for a rating using a dialogue box; having an “unrated” category for just these pages; returning them to the view queue; giving them a predefined rating (probably intermediate); or doing nothing at all. All these variations, including those in which the user is expected to choose between the options, are within the scope of the current invention.

The left pane 206 and its role in recalling previously used pages and search contexts will now be discussed. In the embodiment preferred for user access devices with plenty of screen space, the left pane 206 shows the entire history of search contexts, using scrollbars when required, each context being represented by a collapsed tree node on a single line 207, except for the current context 208 which is expanded to show the three rating categories. The high and intermediate categories are expanded by default to list the pages thus rated 209, 210 while the less useful “bad” category 211 is collapsed to save space. The bad category is included here so that users will not fear that they can never recall a page if they badly rate it by accident or if they change their minds. Such a fear would inhibit them from rating anything badly and thus defeat the object of the invention. Clicking on a page 209, 210 in the left pane directs the viewing area 212 to show the page immediately. In most cases it will still be in the cache fully rendered and should appear immediately. The previous page may be dismissed without a rating as discussed above.

As well as clicking on pages in the left pane, the user may click on a search context 207. In this case, the selected context becomes the current one, its node in the left pane is expanded while the previously active context's node is collapsed, and some page from the selected context is displayed. Options as to which page it should be include: the one that was visible when it last ceased to be the current context; a highly rated page in the context; some intermediately rated page (the rationale being that intermediate pages are still under consideration); and any page that was still in the view queue when it last ceased to be the current context. The last option implies that a view queue is required for each search context. All these variations and trivial variations over and above those mentioned are within the scope of the current invention.

In the embodiment that uses automatic context matching, a user who is accustomed to the suggested usage model is unlikely to click on contexts in the left pane very often, because entering similar search terms does the same job without having to search through the list. For this reason, the left pane is not strictly necessary and devices with limited screen space might choose to make the rated pages of the current context available in a more economical fashion. One option is a secondary gesture on a rating button. For instance, a long click or drag action from a rating button 203-205 would cause the list of correspondingly rated pages to appear. The left pane may show the unrated category if it exists. Embodiments without a left pane should avoid having a special category for unrated pages as there would be no suitable place to make it accessible from. The left pane would be the appropriate place to show the contents of the view queue if this were desired, but the preferred embodiment avoids this as explained above.

The suppression of used links will now be discussed. The preferred embodiment suppresses links to pages that are already rated in any category of the current context or that are currently in the view queue or displayed in the viewing area. The principle here is that links on web pages or search results are only for discovering pages whose existence the user is as yet unaware of, whereas already discovered pages are to be found in the categories or view queue. This same principle underlies the removal of back and forward buttons. Links appearing on web pages and search results are thus guaranteed to yield novel pages. This “suppression” could take the form of a strike-out font and should be unambiguous in spite of any CSS styles specified by the page developer. In spite of the strike-out font, the link may actually have its usual effect of navigating to the target page. It is an embodiment-specific design choice whether or not seen and/or rated pages may ever exist in the view queue. If not, then single clicks on suppressed links must either go directly to the target page, or be entirely inert, or draw attention to the categories in the hope of training the user into following the new usage model.

Usage scenarios that don't resemble search will now be discussed. There are times when the user is not searching for anything at all, or at least not by using search engines. These include: viewing a URL recommended in an email or offline medium; wandering through news or magazine-like sites that the user expects to contain unexpected novelties; searching catalogue-like sites for auctioned items, jobs, real estate, etc.; clicking through photo galleries in a linear fashion; and using complex web applications like Gmail or Facebook. Some of these examples also exhibit the expanding/contracting phases and thus benefit from the present invention; for the others, the novel usage model does neither harm nor good. Often, the problem of what search context to allocate the activity to is prominent, and the solution of having a special “null” context must be resorted to. The rating server should be informed of the “null-ness” of these contexts. The scenarios listed above will now be considered in order.

Browsers can typically be launched by clicking on a link in some external document. The preferred embodiment would open in the state it was last in (if it is not already open) and treat the event like a double click. Either the null context can be used or a new context can be created. Between these two extremes, there is an option in which the page could start in the null context but if more pages were opened from links in the initial page, then a context could be created for the entire activity. If the same external link was clicked on again later, then the same context would be used as the first time the external link was used, whether that be the null context or a specific one.

Magazine-like sites are generally visited often by certain users and have both listing pages that change frequently and specific articles that only change under exceptional circumstances, such as in the event of a complaint. The users know the URLs of the front page and are likely to enter an exact URL or double-click to the site's front page from the top of the search results. Either way, a search context would be in place for the magazine site. The new usage model would aid browsing of these sites by supporting queuing of potentially interesting articles, retention of favourites even in case of them being removed, blocking of boring ones and marking of read ones.

The comments above also apply to catalogue sites but the ergonomic benefits are all the more dramatic when people are browsing through large numbers of items and wanting to sort them by suitability. Most catalogue sites provide watch lists or shopping trolleys but each site has a different mechanism presenting its own learning curve. Few catalogue sites provide a mechanism for inhibiting items that have been ruled out. It would be desirable to intercept the search controls of the individual catalogue sites so that search contexts could be created per type of sought item, rather than per site. For large catalogue sites, this would be worthwhile and covered by the scope of the present invention. For the others, the benefits of the categories are still apparent.

Another way to group catalogue searches by topic is to provide a manual means of creating and switching to a new context, even in the embodiment that uses automatic matching. However, this belief that the user can be expected to predict in advance how complex or memorable an activity might become, lies at the heart of what the present invention is trying to overturn. It would similarly be against the spirit of the invention to expect the user to manually restructure the context set after or during the search, but embodiments that make either of these compromises, including those that support a tree structure of contexts within contexts, would be within the scope of the current invention.

Photo galleries and other content intended to be viewed sequentially provide the main reason for the double-click feature. Few ratings are obtained but especially nice pictures can still be flagged for retention. Such content is usually accessed through a link in an email or web application (see below) so a new or null context would be used as in the case of other external links discussed above. In the case that the gallery is accessed through a search, it is correct that the invention as described would use the ongoing context.

Web-based applications typically use AJAX technology which presents the problem that the URL is no guide to what is actually being displayed, and the present invention would not necessarily recall the expected page by re-requesting a particular URL. This renders the categories rather useless. However, this problem causes disruption in many other areas and the increasingly popular REST standard is meant to solve it by restoring the one to one mapping between URLs and entities that a user would recognise. “RESTful” sites are compatible with the categorising and recalling features of the present invention. On the whole, these applications have such specific and varied purposes that one should not speculate about usage models different from what the designers of those particular sites intended. Non-RESTful AJAX sites can still be browsed with the present invention using mainly double-clicks. In many cases the view queue would still be useful, for instance, in an online email service, interesting emails from the inbox can be added to the view queue and read in order. The user is aware of the effects of the single and double clicks and can use whichever is most appropriate in a given part of a given web application.

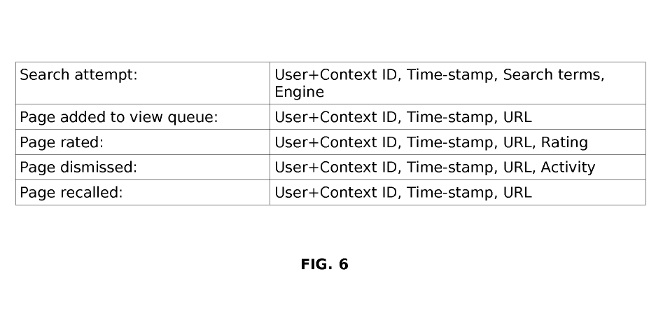

The uploading of data to the rating server will now be discussed with reference to FIG. 6, wherein the association between various user actions and corresponding information data is represented in a tabular form. The web browsing platform sends an unprocessed list of raw events to the rating server containing the maximum data. The web browsing platform should not take the responsibility of processing such data and discarding the raw events on which its conclusions are based, because the art of analysing such data is likely to advance quickly, and old data could be re-analysed in the light of such advances. The rating server should merely archive the raw data and leave the analysis to the expertise of the individual search engines. Some web browsing platforms have business relationships with some search engines and may therefore bypass the rating server and send the data directly to the search engine. Combining the rating server and search engine into a singe physical machine does not change the nature of the system or go beyond the scope of the present invention.

The events of interest are listed in FIG. 6. They are: the entry of new keywords within a new or existing search context; the addition of a page to the view queue; the rating of a page; the dismissal of a page from the viewing area; and the recall of a viewed page by way of the left pane or alternative mechanism. The dismissal of a page using a rating button comprises two of the above events, and may be uploaded as two separate events or as a sixth type of event containing the union of the two events' data. Summoning a page directly using a double-click is also potentially of interest and may have an uploadable event defined for it.

Privacy concerns permitting, it would be ideal to create a globally unique ID for each user and an ID for each search context that is unique within the scope of that user. However, it may be more socially acceptable to obfuscate the association between users and search contexts and use a globally unique ID for each search context. Either way, the union of these data is referred to herein as “User+Context ID.” All of the events include the User+Context ID and a time stamp. All but the search event also specify exactly one URL. The search event further specifies the search terms as input by the user and where applicable the modified version actually sent to the search engine, and also which search engine was used. From this, analyses may recreate the list of pages returned, but the option of also listing the returned pages in the search event is available. The all-important rating event only needs the rating itself over and above the ID, time stamp and URL, while the dismissal event may also include “activity” measurements as described above.

This model supports the case that users change the ratings of already rated pages: as the rating events are updated with timestamps to the rating server at the moment they take place, search engines analysing the data have access to the full history of ratings and re-ratings of each page and may draw whatever conclusions they wish from this sequence of events.

Some embodiments of the web browsing platform may allow the user to inhibit the uploading of this data, but the preferred embodiment requires permission to upload this data as payment for the enhanced user experience. Enlightened users will be glad of the opportunity to “vote” on which pages search engines should favour.

What is claimed is:

1. A non-transitory computer-readable medium having processor executable instructions that when executed, cause a computing device to perform a method for displaying web published content in an arrangement that makes more interesting web pages easier to find, said method comprising: (a) the provision of a convenient action by which the user can add the page targeted by a link on the currently viewed page to a queue of pages intended for imminent inspection, henceforth referred to as the “view queue”, without removing or obscuring the currently viewed page; (b) the provision of convenient actions by which the user can simultaneously store a rating of relevance or interest value of the currently viewed page and cause the currently viewed page to be hidden and replaced with one selected from the view queue or recent viewing history.

2. The method of claim 1, wherein the computing device is a desktop computer, a laptop computer, a tablet computer, a PDA, a smart phone, a mobile phone, or the like.

3. The method of claim 1, wherein the action causing a link to be added to the queue of pages to be imminently viewed is the most likely or convenient of possible user actions on a link, such as a single left button mouse click or single brief touchscreen tap on the link.

4. The method of claim 1, wherein the actions causing the current page to be rated, dismissed and replaced comprise a set of buttons; one button being provided for each rating.

5. The method of claim 1, wherein a secondary user action on a link such as a double click or long tap causes the page targeted by the link to be displayed as soon as it can be loaded and rendered without first being stored in the view queue.

6. The method of claim 1, wherein a secondary user action on a rating button such as a click or tap of longer duration causes a corresponding rating for the page to be stored without the page being dismissed and replaced with another from the view queue or history.

7. The method of claim 1, wherein the set of rating categories with which a page may be associated includes any combination of but is not limited to: pages with long term reference value; pages with no such value; pages for which the assessment of that value has been postponed to the near future; pages which were dismissed without a rating being obtained; pages that were selected for direct viewing as opposed to being added to the view queue; and search suggestions which were not selected by the user.

8. The method of claim 1, wherein the allocation of limited persistent and transient memory resources for caching pages in both the long and short terms depends on the ratings of the pages.

9. The method of claim 1, wherein links to pages which are members of some subset of the rating categories and/or view queue are suppressed using an appropriate font and on-click behavior.

10. The method of claim 1, wherein for some subset of the rating categories, the user may view a list of pages in that category and recall one of those pages by navigating to and activating the corresponding item in said list by way of some pointing device or keyboard actions.

11. The method of claim 1, wherein search attempts are grouped into a multiplicity of search contexts based on inspection of any search terms entered by the user to either a provided search term entry box or directly to a search engine's page.

12. The method of claim 11, wherein one of the said search contexts is nominated as the current focus of the user's attention, henceforth referred to as the “current context”.

13. The method of claim 11, wherein said grouping is a trivial one-to-one correspondence between search attempts and search contexts.

14. The method of claim 11, wherein said grouping is determined by the user using buttons or multiple keyword input boxes or similar to indicate context changes and resumptions.

15. The method of claim 11, wherein said grouping is determined by automatic comparison of newly entered search keywords or their search results with previous search attempts and contexts.

16. The method of claim 11, wherein all ratings and categorizations of pages are local to a specific search context such that said categorizations of a given page may vary from one search context to another.

17. The method of claim 16, wherein the user may view a representation of some subset of the historical search contexts including representations of the rating categories and pages allocated to those categories with respect to those search contexts in which user actions on representations of search contexts and/or pages have the effect of making the indicated context or page current or visible.

18. The method of claim 11, wherein the search terms sent to the search engine are not identically the ones typed in by the user but a modified search string which takes into account information stored in relation to the current search context.

19. The method of claim 11, wherein a special “null” search context is used for searches or pages that cannot meaningfully be allocated to a concrete search context for whatever reason.

20. The method of claim 1, wherein any subset of any collected information about user identity and/or behavior and/or search contexts, as well as any rating categorizations of pages either in the general scope or with respect to certain search contexts is uploaded to an external server.
